(19) United States
(12) Patent Application Publication
(10) Pub. No.: US 2023/0399508 A1
(43) Pub. Date: Dec. 14, 2023

(54) Thermoplastic Resin Composition and Article Manufactured Using Same

(71) Applicant: LOTTE CHEMICAL CORPORATION, Seoul (KR)

(72) Inventors: Jaekeun HONG, Uiwang-si (KR); Keehae KWON, Uiwang-si (KR); Kyoungju KIM, Uiwang-si (KR)

(21) Appl. No.: 18/032,942

(22) PCT Filed: Oct. 27, 2021
(86) PCT No.: PCT/KR2021/015189

§ 371 Date: Apr. 20, 2023

(30) Foreign Application Priority Data
Oct. 30, 2020 (KR) 10-2020-0143863

(51) Int. Cl. C08L 69/00; C08L 9/06

(52) U.S. Cl. CPC C08L 69/00; C08L 9/06; C08L 2207/04; C08L 2205/03; C08L 2207/53

(57) ABSTRACT

Provided is a thermoplastic resin composition having improved low-gloss properties, antibacterial properties, fluidity, and impact resistance, the thermoplastic resin composition including: based on 100 parts by weight of a base resin that includes (A) 50 to 70 wt % of a polycarbonate (PC) resin; and (B) 30 to 50 wt % of a butadiene-based rubber-modified aromatic vinyl-vinyl cyanide copolymer resin including a large-diameter butadiene-based rubbery polymer having an average particle diameter of 1,000 to 6,000 nm, (C) 1 to 6 parts by weight average molecular weight of 1,000,000 to 2,000,000 g/mol; and (D) 1 to 5 parts by weight of zinc oxide (ZnO).

### TECHNICAL FIELD

It relates to a thermoplastic resin composition and an article manufactured using same.

### BACKGROUND ART

A polycarbonate (PC) resin is one of engineering plastics, and is a material that is widely used in the plastics industry.

The polycarbonate resin has a glass transition temperature (Tg) of about 150° C. due to a bulk molecular structure, such as bisphenol-A, which shows high heat resistance and may be an amorphous polymer having excellent transparency.

Furthermore, although having excellent impact resistance and compatibility with other resins, the polycarbonate resin has a drawback of low fluidity, so it is frequently used in a form of an alloy with various resins for complementing moldability and post-processability.

Among them, a polycarbonate/acrylonitrile-butadiene-styrene copolymer (PC/ABS) alloy has excellent durability, moldability, heat resistance, impact resistance, dimensional stability, and the like, and thus may be applied in a wide range of applications such as an electrical/electronic field, an automobile field, a construction field, and other daily life materials.

Recently, there has been an emerging need for automotive interior materials with enhanced low-gloss properties for luxurious appearances. In order to realize the low-gloss properties, a method of reducing surface gloss by introducing several micrometer-sized acrylic particles, an inorganic filler, or the like into a PC/ABS alloy but may have a problem of greatly deteriorating impact resistance.

On the other hand, as businesses of sharing cars such as shared cars, rental cars, etc. are being more active, an interest in interior cleanliness and hygiene of vehicles is increasing, thereby gradually increasing a demand for automotive interior materials with excellent antibacterial properties.

Accordingly, development of a thermoplastic resin composition having excellent low-gloss properties, antibacterial properties, impact resistance, fluidity, and the like is required.

### DISCLOSURE

### Description of the Drawings

### Technical Problem

A thermoplastic resin composition having improved low-gloss properties, antibacterial properties, fluidity, and impact resistance is provided.

Another embodiment provides an article manufactured from the thermoplastic resin composition.

### Technical Solution

According to an embodiment, a thermoplastic resin composition having improved low-gloss properties, antibacterial properties, fluidity, and impact resistance is provided, the thermoplastic resin composition including: based on 100 parts by weight of a base resin that includes (A) 50 to 70 wt % of a polycarbonate (PC) resin; and (B) 30 to 50 wt % of a butadiene-based rubber-modified aromatic vinyl-vinyl cyanide copolymer resin including a large-diameter butadiene-based rubbery polymer having an average particle diameter of 1,000 to 6,000 nm, (C) 1 to 6 parts by weight of an ultra-high molecular weight acrylic copolymer having a weight average molecular weight of 1,000,000 to 2,000,000 g/mol; and (D) 1 to 5 parts by weight of zinc oxide (ZnO).

The (A) polycarbonate resin may have a weight average molecular weight of 10,000 to 100,000 g/mol.

The (B) butadiene-based rubber-modified aromatic vinyl-vinyl cyanide copolymer resin including the large-diameter butadiene-based rubbery polymer having an average particle diameter of 1,000 to 6,000 nm may include a continuous phase of an aromatic vinyl-vinyl cyanide copolymer and a dispersed phase of a butadiene-based rubber-modified aromatic vinyl-vinyl cyanide graft copolymer having a core-shell structure including the large-diameter butadiene-based rubbery polymer.

The aromatic vinyl-vinyl cyanide copolymer may be a styrene-acrylonitrile copolymer.

The (B) butadiene-based rubber-modified aromatic vinyl-vinyl cyanide graft copolymer having the core-shell structure including the large-diameter butadiene-based rubbery polymer having an average particle diameter of 1,000 to 6,000 nm may be an acrylonitrile-butadiene-styrene graft copolymer.

The (C) ultra-high molecular weight acrylic copolymer having a weight average molecular weight of 1,000,000 to 2,000,000 g/mol may be an ultra-high molecular weight methyl methacrylate-ethyl acrylate copolymer.

The (D) zinc oxide may have an average particle diameter of 0.5 to 3 μm and a BET specific surface area of 1 to 10 m²/g.

The (D) zinc oxide has a peak position 26 value of 35 to 37° in X-ray diffraction (XRD) analysis, and a crystallite size value according to Equation 1 of 1,000 to 2,000 Å.

$$Crystallite size ( D ) = \frac{k λ}{β cos θ} \qquad [ Equation 1 ]$$

In Equation 1, k is a shape factor, A is an X-ray wavelength, p is a FWHM value (degrees) of an X-ray diffraction peak, and 6 is a peak position value (degrees).

The (D) zinc oxide may have a size ratio (B/A) of a peak B in a 450 to 600 nm region to a peak A in a 370 to 390 nm region of 0.01 to 1 when measuring photoluminescence.

According to an embodiment, the thermoplastic resin composition may further include at least one additive selected from a flame retardant, a nucleating agent, a coupling agent, a filler, a plasticizer, an impact modifier, a lubricant, a release agent, a heat stabilizer, an antioxidant, an UV stabilizer, a pigment, and a dye.

According to another embodiment, an article manufactured from the aforementioned thermoplastic resin composition is provided.

The article may have a gloss of 5 to 25 GU measured at a reflection angle of 60° according to ASTM D523.

The article may have a melt flow index of 20 to 50 g/10 min measured under a condition of 250° C. and a 10 kg load according to ASTM D1238.

The article may have a notched Izod impact strength of 25 to 50 kgf·cm/cm for a ⅛″-thick specimen according to ASTM D256.

### Advantageous Effects

The thermoplastic resin composition may have improved low-gloss properties, antibacterial properties, fluidity, and impact resistance, and articles manufactured therefrom.

### MODE FOR INVENTION

Hereinafter, embodiments of the present invention are described in detail. However, these embodiments are exemplary, the present invention is not limited thereto and the present invention is defined by the scope of claims.

In the present specification, unless otherwise mentioned, “copolymerization” refers to block copolymerization, random copolymerization, or graft-copolymerization, and “copolymer” refers to a block copolymer, a random copolymer, or a graft copolymer.

In the present specification, unless otherwise mentioned, the average particle diameter of the rubbery polymer refers to a volume average diameter, and means a Z-average particle diameter measured using a dynamic light scattering analyzer.

In the present specification, unless otherwise mentioned, the average particle diameter of zinc oxide is a particle diameter (D50) corresponding to 50% of a weight percentage in a particle size distribution curve of single particles (particles do not aggregate to form secondary particles), which are measured by using a particle size analyzer (Laser Diffraction Particle Size Analyzer LS 13 320 equipment, Beckman Coulter, Inc.).

In the present specification, unless otherwise mentioned, the weight average molecular weight is measured by dissolving a powder sample in an appropriate solvent and performing gel permeation chromatography (GPC) with a 1200 series made by Agilent Technologies Inc. (a column: LF-804 made by Shodex, a standard sample: polystyrene made by Shodex).

In the present specification, unless otherwise mentioned, the specific surface area of zinc oxide is measured using a nitrogen gas adsorption method with a BET analysis equipment (Surface Area and Porosity Analyzer ASAP 2020 manufactured by Micromeritics Instrument Co.).

A thermoplastic resin composition according to an embodiment includes, based on 100 parts by weight of a base resin that includes (A) 50 to 70 wt % of a polycarbonate (PC) resin; and (B) 30 to 50 wt % of a butadiene-based rubber-modified aromatic vinyl-vinyl cyanide copolymer resin including a large-diameter butadiene-based rubbery polymer having an average particle diameter of 1,000 to 6,000 nm, (C) 1 to 6 parts by weight of an ultra-high molecular weight acrylic copolymer having a weight average molecular weight of 1,000,000 to 2,000,000 g/mol; and (D) 1 to 5 parts by weight of zinc oxide (ZnO).

Hereinafter, each component included in the thermoplastic resin composition will be described in detail.

### (A) Polycarbonate Resin

The polycarbonate resin is a thermoplastic resin having a repeating unit of a carbonate unit but has no particular limit in its type, and may include any polycarbonate resin usable in the resin composition field.

For example, it may be prepared by reacting a diphenol compound represented by Chemical Formula 1 with a compound selected from phosgene, halogen acid esters, carbonate esters, and a combination thereof.

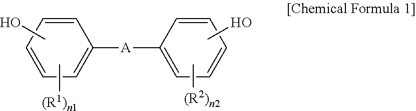

In Chemical Formula 1,

A is a linking group selected from a single bond, a substituted or unsubstituted C1 to C30 alkylene group, a substituted or unsubstituted C2 to C5 alkenylene group, a substituted or unsubstituted C2 to C5 alkylidene group, a substituted or unsubstituted C1 to C30 haloalkylene group, a substituted or unsubstituted C5 to C6 cycloalkylene group, a substituted or unsubstituted C5 to C6 cycloalkenylene group, a substituted or unsubstituted C5 to C10 cycloalkylidene group, a substituted or unsubstituted C6 to C30 arylene group, a substituted or unsubstituted C1 to C20 alkoxylene group, a halogenic acid ester group, a carbonate ester group, —Si(—R¹¹)(—R¹²), —O—, —S—, and —S(═O)₂—, wherein R¹, R², R¹¹, and R¹² are each independently a substituted or unsubstituted C1 to C30 alkyl group or a substituted or unsubstituted C6 to C30 aryl group, and n1 and n2 are each independently an integer ranging from 0 to 4.

Two or more types of the diphenol compound represented by Chemical Formula 1 may be combined to constitute a repeating unit of the polycarbonate resin.

Specific examples of the diphenol compound may be hydroquinone, resorcinol, 4,4′-dihydroxydiphenyl, 2,2-bis(4-hydroxyphenyl)propane (also referred to as “bisphenol-A”), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3-methyl-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like. Among the diphenol compound, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(3,5-dichloro-4-hydroxyphenyl)propane, or 1,1-bis(4-hydroxyphenyl)cyclohexane may be desirably used. 2,2-bis(4-hydroxyphenyl)propane may be more desirably used.

The polycarbonate resin may be a mixture of copolymers obtained using two or more dipenols compound.

In addition, the polycarbonate resin may be a linear polycarbonate resin, a branched polycarbonate resin, or a copolymer resin polycarbonate and other polymers, for example, a polycarbonate-polysiloxane copolymer resin, a polyester-polycarbonate copolymer resin, and the like.

Specific examples of the linear polycarbonate resin may be a bisphenol-A polycarbonate resin. Specific examples of the branched polycarbonate resin may be a resin by reacting a multi-functional aromatic compound such as trimellitic anhydride, trimellitic acid, and the like with diphenol compound and a carbonate. The polycarbonate-polysiloxane copolymer resin may include a resin prepared by reacting a siloxane compound having a hydroxyl terminal end group with a diphenol compound, phosgene, halogen formate, carbonic acid diester, and the like.

The polyester-polycarbonate copolymer resin may be prepared by reacting a difunctional carboxylic acid with a diphenol compound and a carbonate, and the carbonate used herein may be diaryl carbonate such as diphenyl carbonate or ethylene carbonate.

The polycarbonate resin may be prepared using an interfacial polymerization method (also called a solvent method (solvent polymerization) or a phosgene method), a melt polymerization method, or the like.

When the polycarbonate resin is prepared by a melt polymerization method, the transesterification reaction may be performed at a temperature of 150 to 300° C., for example 160 to 280° C., or specifically 190 to 260° C. under reduced pressure conditions of less than or equal to 100 torr, for example less than or equal to 75 torr, specifically, less than or equal to 30 torr, or more specifically less than or equal to 1 torr, for at least 10 minutes or more, for example, 15 minutes to 24 hours, or specifically 15 minutes to 12 hours. Within the above ranges, the reaction rate and side reactions may be desirably reduced, and gel formation may be reduced.

The reaction may be performed in the presence of a catalyst. As the catalyst, a catalyst used in a conventional transesterification reaction, for example, an alkali metal catalyst, an alkaline earth metal catalyst, etc. may be used. Examples of the alkali metal catalyst may include LiGH, NaOH, KOH, and the like, but is not limited thereto. These may be used alone or in mixture of 2 or more types. The content of the catalyst may be used in the range of 1×10⁻⁸ to 1×10⁻³ mol, for example, 1×10⁻⁷ to 1×10⁻⁴ mol per 1 mol of the diphenol compound. Sufficient reactivity may be obtained within the above range, and the generation of by-products due to side reactions may be minimized, thereby improving thermal stability and color tone stability.

When the polycarbonate resin is prepared by an interfacial polymerization method, although detailed reaction conditions may be variously adjusted, for example, the following method may be adopted: a reactant of an diphenol compound is dissolved or dispersed in caustic soda of water or potash, and the mixture is added to a water-immiscible solvent, so that the reactant may contact a carbonate precursor, for example, under a pH condition adjusted to about 8 to about 10 and under presence of triethylamine, a phase transfer catalyst, or the like.

Examples of the water-immiscible solvent may include methylene chloride, 1,2-dichloroethane, chlorobenzene, toluene, and the like.

Examples of the carbonate precursor may include a carbonyl halide such as carbonyl bromide or carbonyl chloride, a haloformate such as bishaloformate of dihydric phenols (e.g., bischloroformate such as bisphenol A and hydroquinone) or a haloformate such as a bishaloformate of glycol (e.g., a bishaloformate such as ethylene glycol, neopentyl glycol, or polyethylene glycol).

Examples of the phase transfer catalyst may include [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)_{3]3}NX, CH₃[CH₃(CH₂)_{2]3}NX, wherein X is selected from a halogen, a C1 to C8 alkoxy group, and a C6 to C18 aryloxy group), and the like.

The polycarbonate resin may have a weight average molecular weight of 10,000 g/mol to 100,000 g/mol, for example 12,000 g/mol to 100,000 g/mol, for example 12,000 g/mol to 90,000 g/mol, for example 14,000 to 90,000 g/mol, for example 14,000 to 80,000 g/mol, for example 14,000 to 70,000 g/mol, or for example 14,000 to 50,000 g/mol. When the weight average molecular weight of the polycarbonate resin is within the above ranges, an article manufactured therefrom may obtain excellent impact resistance and fluidity.

The polycarbonate resin may have for example a melt flow index (MI) of 5 to 40 g/10 min, for example 8 to 40 g/10 min, for example 8 to 35 g/10 min, for example 10 to 35 g/10 min, or for example 10 to 33 g/10 min, which is measured under the condition of 250° C. and a 10 kg load according to ASTM D1238. When the polycarbonate resin having a melt flow index within the above range is used, an article manufactured therefrom may exhibit excellent impact resistance and fluidity.

The polycarbonate resin may be used by mixing two or more types of polycarbonate resins having different weight average molecular weights or melt flow indexes. By mixing and using polycarbonate resins of different weight average molecular weights or melt flow indexes, the thermoplastic resin composition may be controlled to have desired fluidity and/or impact resistance. The polycarbonate resin may be included in an amount of 40 to 80 wt %, for example greater than or equal to 40 wt %, for example greater than or equal to 45 wt %, for example greater than or equal to 50 wt %, for example greater than or equal to 55 wt %, for example greater than or equal to 60 wt %, for example greater than or equal to 65 wt %, for example greater than or equal to 70 wt %, or for example greater than or equal to 75 wt %, and for example less than or equal to 80 wt %, for example less than or equal to 75 wt %, for example less than or equal to 70 wt %, for example less than or equal to 65 wt %, for example less than or equal to 60 wt %, for example less than or equal to 55 wt %, for example less than or equal to 50 wt %, or for example less than or equal to 45 wt %, based on 100 wt % of the base resin.

When polycarbonate resin is included within the ranges, it is possible to achieve a thermoplastic resin composition and an article manufactured therefrom having improved mechanical strength, heat resistance, formability, and impact resistance.

### (B) Butadiene-Based Rubber-Modified Aromatic Vinyl-Vinyl Cyanide Copolymer Resin Including Large-Diameter Butadiene-Based Rubbery Polymer Having Average Particle Diameter of 1,000 to 6,000 nm

In an embodiment, (B) the butadiene-based rubber-modified aromatic vinyl-vinyl cyanide copolymer resin including the large-diameter butadiene-based rubbery polymer imparts excellent impact resistance and low-gloss properties to the thermoplastic resin composition.

The butadiene-based rubber-modified aromatic vinyl-vinyl cyanide copolymer resin may realize low-gloss properties by including the large-diameter butadiene-based rubbery polymer.

The large-diameter butadiene-based rubbery polymer may have an average particle diameter of 1,000 to 6,000 nm, for example 1,000 to 5,000 nm, for example 1,000 to 4,000 nm, for example 1,000 to 3,000 nm, for example 1,500 to 5,000 nm, for example 1,500 to 4,000 nm, for example 1,500 to 3,500 nm, for example 2,000 to 5,000 nm, for example 2,000 to 4,500 nm, for example 2,000 to 4,000 nm, for example 2,000 to 3,500 nm, for example 2,000 to 3,000 nm, or for example 2,500 to 3,000 nm.

The butadiene-based rubber-modified aromatic vinyl-vinyl cyanide copolymer resin including the large-diameter butadiene-based rubbery polymer may include a continuous phase of an aromatic vinyl-vinyl cyanide copolymer and a dispersed phase of a butadiene-based rubber-modified aromatic vinyl-vinyl cyanide graft copolymer having a core-shell structure including the large-diameter butadiene-based rubbery polymer.

The aromatic vinyl-vinyl cyanide copolymer may be a copolymer of a monomer mixture including an aromatic vinyl compound and a vinyl cyanide compound, and may be prepared by conventional polymerization methods such as emulsion polymerization, suspension polymerization, solution polymerization, and bulk polymerization.

The aromatic vinyl-vinyl cyanide copolymer may have a weight average molecular weight of greater than or equal to 80,000 g/mol, for example greater than or equal to 85,000 g/mol, for example greater than or equal to 90,000 g/mol, or for example greater than or equal to 200,000 g/mol and for example less than or equal to 150,000 g/mol, for example less than or equal to 80,000 g/mol to 200,000 g/mol, or for example 80,000 g/mol to 150,000 g/mol.

The aromatic vinyl compound may be at least one selected from styrene, α-methylstyrene, p-methylstyrene, p-t-butylstyrene, 2,4-dimethylstyrene, chlorostyrene, vinyltoluene, and vinylnaphthalene.

The vinyl cyanide compound may be at least one selected from acrylonitrile, methacrylonitrile, and fumaronitrile.

In an embodiment, the aromatic vinyl-vinyl cyanide copolymer may include 60 to 80 wt % of the component derived from the aromatic vinyl compound and 20 to 40 wt % of the component derived from the vinyl cyanide compound, based on 100 wt % of the aromatic vinyl-vinyl cyanide copolymer.

In an embodiment, the aromatic vinyl-vinyl cyanide copolymer may be a styrene-acrylonitrile copolymer (SAN).

The butadiene-based rubber-modified aromatic vinyl-vinyl cyanide graft copolymer having a core-shell structure including the large-diameter butadiene-based rubbery polymer may be prepared by graft polymerization of a monomer mixture including an aromatic vinyl compound and a vinyl cyanide compound, to a core including a large-diameter butadiene-based rubbery polymer.

The core may be made of a large-diameter butadiene-based rubbery polymer alone or may be made of a mixture of a large-diameter butadiene-based rubbery polymer and a medium-diameter butadiene-based rubbery polymer having an average particle size of 100 to 600 nm.

In addition, a butadiene-based rubber-modified aromatic vinyl-vinyl cyanide graft copolymer having a core-shell structure prepared by graft-polymerizing a monomer mixture of an aromatic vinyl compound and a vinyl cyanide compound to the core made of the large-diameter butadiene-based rubbery polymer and a butadiene-based rubber-modified aromatic vinyl-vinyl cyanide graft copolymer having a core-shell structure prepared by graft-polymerizing a monomer mixture of an aromatic vinyl compound and a vinyl cyanide compound to the core formed of the medium-diameter butadiene-based rubbery polymer may be mixed.

The butadiene-based rubber-modified aromatic vinyl-vinyl cyanide graft copolymer having the core-shell structure including the large-diameter butadiene-based rubbery polymer may be prepared according to any method known to those skilled in the art.

The preparation method may include conventional polymerization methods, for example, emulsion polymerization, suspension polymerization, solution polymerization, and bulk polymerization. According to non-limiting examples of the method, a butadiene-based rubbery polymer is prepared, and at least one layered shell may be formed thereon by graft-polymerizing the monomer mixture of the aromatic vinyl compound and the vinyl cyanide compound to a core having at least one layer of the butadiene-based rubbery polymer may be adopted.

The butadiene-based rubbery polymer may be selected from a butadiene rubbery polymer, a butadiene-styrene rubbery polymer, a butadiene-acrylonitrile rubbery polymer, a butadiene-acrylate rubbery polymer, and a mixture thereof.

The aromatic vinyl compound included in the shell may be at least one selected from styrene, α-methylstyrene, p-methylstyrene, pt-butylstyrene, 2,4-dimethylstyrene, chlorostyrene, vinyltoluene, and vinylnaphthalene, but is not limited thereto.

The vinyl cyanide compound included in the shell may be at least one selected from acrylonitrile, methacrylonitrile, and fumaronitrile, but is not limited thereto.

The shell may be a copolymer of a monomer mixture including the aromatic vinyl compound and the vinyl cyanide compound in a ratio of 6:4 to 9:1, for example, 6:4 to 8:2, or for example, 6:4 to 7:3.

In an embodiment, the butadiene-based rubber-modified aromatic vinyl-vinyl cyanide graft copolymer having a core-shell structure including the large-diameter butadiene-based rubbery polymer may be an acrylonitrile-butadiene-styrene graft copolymer (g-ABS).

In an embodiment, the continuous phase and the dispersed phase may be included in a weight ratio of 9:1 to 5:5, for example 8:2 to 5:5, for example 7:3 to 5:5 based on 100 wt % of the butadiene-based rubber-modified aromatic vinyl-vinyl cyanide copolymer resin including the large-diameter butadiene-based rubbery polymer.

In an embodiment, the butadiene-based rubber-modified aromatic vinyl-vinyl cyanide copolymer resin including the large-diameter butadiene-based rubbery polymer may be included in an amount of 20 to 60 wt %, for example greater than or equal to 20 wt %, for example greater than or equal to 25 wt %, for example greater than or equal to 30 wt %, for example greater than or equal to 35 wt %, for example greater than or equal to 40 wt %, for example greater than or equal to 45 wt %, for example greater than or equal to 50 wt %, or for example greater than or equal to 55 wt %, and for example less than or equal to 60 wt %, for example less than or equal to 55 wt %, for example less than or equal to 50 wt %, for example less than or equal to 45 wt %, for example less than or equal to 40 wt %, for example less than or equal to 35 wt %, for example less than or equal to 30 wt %, or for example less than or equal to 25 wt % based on 100 wt % of the base resin.

When included within the above ranges, the thermoplastic resin composition and the article manufactured therefrom having low-gloss properties, formability, and impact resistance may be achieved.

(C) Ultra-High Molecular Weight Acrylic Copolymer Having Weight Average Molecular Weight of 1,000,000 to 2,000,000 g/Mol

In an embodiment, the (C) the ultra-high molecular weight acrylic copolymer may improve low-gloss properties of the thermoplastic resin composition.

The ultra-high molecular weight acrylic copolymer may have a weight average molecular weight of 1,000,000 to 2,000,000 g/mol, for example greater than or equal to 1,000,000 g/mol, for example greater than or equal to 1,100,000 g/mol, for example greater than or equal to 1,200,000 g/mol, for example greater than or equal to 1,300,000 g/mol, for example greater than or equal to 1,400,000 g/mol, for example greater than or equal to 1,500,000 g/mol, for example greater than or equal to 1,600,000 g/mol, for example greater than or equal to 1,700,000 g/mol, for example greater than or equal to 1,800,000 g/mol, or for example greater than or equal to 1,900,000 g/mol, and for example less than or equal to 2,000,000 g/mol, for example less than or equal to 1,900,000 g/mol, for example less than or equal to 1,800,000 g/mol, for example less than or equal to 1,700,000 g/mol, for example less than or equal to 1,600,000 g/mol, for example less than or equal to 1,500,000 g/mol, for example less than or equal to 1,400,000 g/mol, for example less than or equal to 1,300,000 g/mol, for example less than or equal to 1,200,000 g/mol, or for example less than or equal to 1,100,000 g/mol.

The ultra-high molecular weight acrylic copolymer may be prepared according to any method known to those skilled in the art.

The preparation method may include conventional polymerization methods, for example, emulsion polymerization, suspension polymerization, solution polymerization, and bulk polymerization.

In an embodiment, the ultra-high molecular weight acrylic copolymer, which is a copolymer of alkyl (meth)acrylate-based monomers, may include two or more types of alkyl (meth)acrylate-based monomers as a polymerization unit.

For example, the alkyl (meth)acrylate-based monomer may include at least one of unsubstituted linear or branched alkyl (meth)acrylic acid ester having 1 to 20 carbon atoms, for example, methyl (meth)acrylate, ethyl (meth)acrylate, propyl (meth)acrylate, butyl (meth)acrylate, pentyl (meth)acrylate, hexyl (meth)acrylate, heptyl (meth)acrylate, ethylhexyl (meth)acrylate, octyl (meth)acrylate, (meth)acrylate, decyl (meth)acrylate, and esters thereof but is not limited thereto. Two or more types thereof may be mixed and used as a mixture.

In an embodiment, the (C) ultra-high molecular weight acrylic copolymer may be an ultra-high molecular weight methyl methacrylate-ethyl acrylate copolymer.

In an embodiment, the ultra-high molecular weight acrylic copolymer may be included in an amount of 1 to 6 parts by weight, for example 1 to 6 parts by weight, for example 1 to 5 parts by weight, for example 1 to 4 parts by weight, for example 1 to 3 parts by weight based on 100 parts by weight of the base resin.

When the ultra-high molecular weight acrylic copolymer is included in the above ranges, low-gloss properties of the thermoplastic resin composition may be achieved.

### (D) Zinc Oxide

In an embodiment, the (D) zinc oxide performs a function of imparting antibacterial properties to the thermoplastic resin composition and the article manufactured therefrom, and also functions to improve light resistance and weather resistance.

In an embodiment, the zinc oxide may have an average particle diameter of greater than or equal to 0.5 μm, for example greater than or equal to 0.8 μm, or for example greater than or equal to 1 μm, and for example less than or equal to 3 μm, for example less than or equal to 2.5 μm, for example less than or equal to 2 μm, for example 0.5 to 3 μm, for example 0.5 to 2.5 μm, for example 0.5 to 2 μm, for example 0.8 to 2 μm.

When the average particle diameter of the zinc oxide (D) is out of the above-mentioned range, antibacterial properties and/or appearance characteristics of the thermoplastic resin composition and the article manufactured therefrom may be deteriorated.

The (D) zinc oxide may have a BET specific surface area of greater than or equal to 1 m²/g, and for example less than or equal to 10 m²/g, for example less than or equal to 9 m²/g, for example less than or equal to 8 m²/g, or for example less than or equal to 7 m²/g, or for example 1 to 10 m²/g, or for example 1 to 7 m²/g.

When the BET specific surface area of the (D) zinc oxide is out of the above range, antibacterial properties, light resistance, weather resistance of the thermoplastic resin composition and the article manufactured therefrom may be deteriorated.

The purity of the zinc oxide as measured from a residual weight at a temperature of 800° C. using TGA thermal analysis may be greater than or equal to 99%.

In an embodiment, the zinc oxide may have a peak position 28 value obtained by X-ray diffraction (XRD) analysis of 35 to 37°, and a crystallite size of 1,000 to 2,000 Å, for example 1,200 to 1,800 Å, which is calculated based on the measured FWHM value (full width at half maximum of the diffraction peak) by applying Scherrer's equation represented by Equation 1.

$$Crystallite size = \frac{k λ}{β cos θ} \qquad [ Equation 1 ]$$

In Equation 1, k is a shape factor, λ is an X-ray wavelength, β is a FWHM value (degrees) of an X-ray diffraction peak, and θ is a peak position value (degrees).

Specifically, the crystallite size may be measured by using a high-resolution X-ray diffractometer (PRO-MRD, manufacturer: X'pert) and may be measured regardless of a sample type (e.g., powder form, injection specimen). On the other hand, when an injection specimen is used, XRD may be more accurately analyzed by heat-treating the specimen at 600° C. in the air for 2 hours to remove a residual polymer.

When the crystallite size of the zinc oxide is out of the above range, antibacterial properties, light resistance, and weather resistance of the thermoplastic resin composition and the article manufactured therefrom may be deteriorated.

The (D) zinc oxide may have various shapes, for example, a spherical shape, a plate shape, a rod shape, and a combination thereof. In an embodiment, the zinc oxide may have various shapes other than needle-shaped, for example, spherical, plate-shaped, rod-shaped, etc.

The (D) zinc oxide may have a size ratio (B/A) of a peak B in a 450 to 600 nm region to a peak A in a 370 to 390 nm region, that is a PL size ratio of 0.01 to 1, for example 0.1 to 1, or for example 0.1 to 0.5, when measuring photoluminescence (PL).

The photoluminescence may be measured by putting zinc oxide powder in a pelletizer with a diameter of 6 mm and compressing it to prepare a specimen in a flat state and then irradiating the specimen by a He—Cd laser at a wavelength of 325 nm (30 mW, KIMMON KOHA) at room temperature and detecting a spectrum of light emitted therefrom with a CCD detector, wherein the CCD detector is maintained at −70° C.

Within the above ranges, the thermoplastic resin composition and the article manufactured therefrom may exhibit excellent antibacterial properties, light resistance, weather resistance, and the like.

The (D) zinc oxide may be prepared by melting metallic zinc and then heating it at 850 to 1,000° C., for example, 900 to 950° C. to evaporate it, injecting oxygen gas thereinto, cooling it to 20 to 30° C., and then heating it at 400 to 900° C., for example 500 to 800° C. for 30 to 150 minutes, for example, 60 to 120 minutes.

The (D) zinc oxide may be included in an amount of 1 to 5 parts by weight, for example greater than or equal to 1 part by weight, for example greater than or equal to 2 parts by weight, for example greater than or equal to 3 parts by weight, for example greater than or equal to 4 parts by weight, and for example less than or equal to 5 parts by weight, for example less than or equal to 4 parts by weight, for example less than or equal to 3 parts by weight, or for example less than or equal to 2 parts by weight, based on 100 parts by weight of the base resin.

When the zinc oxide is included in the above ranges, antibacterial properties, light resistance, weather resistance, and impact resistance of the thermoplastic resin composition and the article manufactured therefrom may be improved.

### (E) Additives

The thermoplastic resin composition according to an embodiment may further include at least one additive according to final use of the thermoplastic resin composition in addition to the components (A) to (D) in order to secure excellent low-gloss properties, antibacterial properties, and impact resistance and balance each property without deteriorating the other properties.

Specifically, the additives may include at least one additive selected from a flame retardant, a nucleating agent, a coupling agent, a filler, a plasticizer, an impact modifier, a lubricant, a release agent, a heat stabilizer, an antioxidant, an ultraviolet (UV) stabilizer, a pigment, a dye, and the like and may be used alone or in a combination of two or more.

These additives may be appropriately included within a range that does not impair the physical properties of the thermoplastic resin composition, and specifically, may be included in an amount of less than or equal to 20 parts by weight based on 100 parts by weight of the base resin, but are not limited thereto.

On the other hand, the thermoplastic resin composition according to an embodiment may be mixed with other resin or other rubber component and used together.

Another embodiment provides an article manufactured using a thermoplastic resin composition according to an embodiment. The article may be produced by various methods known in the art, such as injection molding and extrusion molding using the thermoplastic resin composition.

The article may have a gloss of 5 to 25 GU measured at a reflection angle of 60° according to ASTM D523. For example, the gloss may be greater than or equal to 5 GU, greater than or equal to 10 GU, greater than or equal to 15 GU, or greater than or equal to 20 GU, and less than or equal to 25 GU, less than or equal to 20 GU, less than or equal to 15 GU, or less than or equal to 10 GU.

The article may have a melt flow index of 20 to 50 g/10 min measured under a condition of 250° C. and 10 kg load according to ASTM D1238. For example, the melt flow index may be greater than or equal to 20 g/10 min, greater than or equal to 25 g/10 min, greater than or equal to 30 g/10 min, greater than or equal to 35 g/10 min, greater than or equal to 40 g/10 min, or greater than or equal to 45 g/10 min and less than or equal to 50 g/10 min, less than or equal to 45 g/10 min, less than or equal to 40 g/10 min, less than or equal to 35 g/10 min, less than or equal to 30 g/10 min, or less than or equal to 25 g/10 min.

The article may have a notched Izod impact strength of 25 to 50 kgf·cm/cm for a ⅛″-thick specimen according to ASTM D256. For example, the Impact strength may be greater than or equal to 25 kgf·cm/cm, greater than or equal to 30 kgf·cm/cm, greater than or equal to 35 kgf·cm/cm, greater than or equal to 40 kgf·cm/cm, or greater than or equal to 45 kgf·cm/cm and less than or equal to 50 kgf·cm/cm, less than or equal to 45 kgf·cm/cm, less than or equal to 40 kgf·cm/cm, less than or equal to 35 kgf·cm/cm, or less than or equal to 30 kgf·cm/cm.

In this way, the article has excellent low-gloss properties, antibacterial properties, and impact resistance and thus may be advantageously applied to various electronic parts, building materials, sport goods, automotive interior/exterior parts.

Hereinafter, the present invention is illustrated in more detail with reference to examples. These examples, however, are not in any sense to be interpreted as limiting the scope of the invention.

### Examples 1 to 6 and Comparative Examples 1 to 5

The thermoplastic resin compositions of Examples 1 to 6 and Comparative Examples 1 to 5 were prepared according to the component content ratios described in Tables 1 and 2.

In Tables 1 and 2, (A) and (B), which were included in the base resin, were expressed in wt % based on a total weight of the base resin, and (C) and (D), which were added to the base resin, were expressed as parts by weight based on 100 parts by weight of the base resin.

The components listed in Tables 1 and 2 were quantitatively and continuously introduced into a feeding unit of a twin-screw extruder (L/D=44, D=35 mm) (barrel temperature: about 260° C.), and then extruded/processed, preparing pellet-type thermoplastic resin compositions. Subsequently, after the thermoplastic resin compositions that were pelletized through a twin-screw extruder are dried at about 80° C. for about 2 hours, specimens for physical property evaluation were produced, respectively, using a 6 oz injection molding machine set to a cylinder temperature of about 250° C. and a mold temperature of about 60° C.

TABLE 1

| | | Ex. 1 | Ex. 2 | Ex. 3 | Ex. 4 | Ex. 5 | Ex. 6 |
|---|---|---|---|---|---|---|---|
| (A) | wt % | 65 | 65 | 65 | 65 | 65 | 55 |
| (B) | wt % | 35 | 35 | 35 | 35 | 35 | 45 |
| (C) | parts by weight | 2 | 2 | 2 | 4 | 4 | 2 |
| (D) | parts by weight | 1 | 2 | 3 | 1 | 2 | 2 |

TABLE 2

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| (A) | wt % | 65 | 65 | 65 | 65 | 65 |
| (B) | wt % | 35 | 35 | 35 | 35 | 35 |
| (C) | parts by weight | 2 | 4 | 0.1 | 10 | 2 |
| (D) | parts by weight | — | — | 1 | 1 | 8 |

### (A) Polycarbonate Resin

A bisphenol-A-based polycarbonate resin having a melt flow index of about 13 g/10 min, which was measured at 250° C. under a load condition of 10 kg according to ASTM D1238, and a weight average molecular weight of about 28,000 g/mol (Lotte Chemical Corp.) was used.

### (B) ABS Resin Including Large-Diameter Rubbery Polymer

An acrylonitrile-butadiene-styrene copolymer (ABS) resin including about 11 wt % of an acrylonitrile-butadiene-styrene graft copolymer (g-ABS) having a butadiene rubbery polymer having an average particle diameter of about 4,500 nm in a dispersed phase and a styrene-acrylonitrile copolymer (SAN) having a weight average molecular weight of about 150,000 g/mol in a continuous phase in a weight ratio of about 6:4 (Lotte Chemical Corp.) was used.

### (C) Ultra-High Molecular Weight Acrylic Copolymer

A methyl methacrylate-ethyl acrylate copolymer having a weight average molecular weight of about 1,500,000 g/mol (DOW Chemical Company) was used.

### (D) Zinc Oxide

Zinc oxide (Hanil Chemical Co., Ltd.) having a density of 5.47 to 5.64 g/cm³, pH 6.95 to 7.37, an (absolute) refractive index of 1.94 to 2.11, an average particle diameter (D50) of about 1.2 μm, a BET specific surface area of about 4 m²/g, purity of about 99%, a PL size ratio (B/A) of about 0.28, and a crystallite size of about 1,417 Å was used.

### Evaluation of Physical Properties

Antibacterial properties, gloss, fluidity, and impact resistance of the specimens for evaluating properties according to Examples 1 to 6 and Comparative Examples 1 to 5 were measured, and the results are shown in Tables 3 and 4.

(1) Antibacterial properties: According to a JIS Z 2801 antibacterial evaluation method, antibacterial activity was measured by inoculating Staphylococcus aureus (ATCC 6538P) and Escherichia coli (ATCC 8739) to the specimens having a 45 mm×45 mm×3.2 mm size and culturing them at 35° C. under relative humidity (RH) of 90% for 24 hours. When an antibacterial activity value was 2.0 or higher, it was considered to have an antibiotic effect.

(2) Gloss (unit: GU): A specimen with a size of 45 mm×45 mm×3.2 mm was measured with respect to gloss at a reflection angle of 60° according to ASTM D523. The lower the gloss, the more excellent the low-gloss properties.

(3) Fluidity (unit: g/10 min): According to ASTM D1238, a melt flow index (MI) was measured at 220° C. under a load condition of 10 kg.

(4) Impact Resistance (unit: kgf·cm/cm): According to ASTM D256, ⅛″-thick specimens were measured with respect to notched Izod Impact strength.

TABLE 3

| | | Ex. 1 | Ex. 2 | Ex. 3 | Ex. 4 | Ex. 5 | Ex. 6 |
|---|---|---|---|---|---|---|---|
| Antibacterial | Staphylococcus | 4.5 | 4.6 | 4.6 | 4.6 | 4.6 | 4.6 |
| activity value | aureus | | | | | | |
| | Escherichia coli | 6.2 | 6.2 | 6.2 | 6.1 | 6.2 | 6.2 |

| | | | | | | |
|---|---|---|---|---|---|---|
| Gloss | 20 | 19 | 19 | 10 | 8 | 9 |
| Melt flow index | 33 | 34 | 36 | 27 | 28 | 38 |
| Izod Impact strength | 45 | 42 | 40 | 40 | 38 | 39 |

TABLE 4

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| Antibacterial | Staphylococcus | 0 | 0 | 4.5 | 4.6 | 4.6 |
| activity value | aureus | | | | | |
| | Escherichia coli | 0.4 | 0.5 | 6.2 | 6.1 | 6.2 |

| | | | | | |
|---|---|---|---|---|---|
| Gloss | 31 | 24 | 75 | 6 | 30 |
| Melt flow index | 32 | 25 | 52 | 14 | 47 |
| Izod Impact strength | 44 | 42 | 49 | 12 | 12 |

Referring to Tables 1 to 4, the thermoplastic resin compositions according to example embodiments exhibited excellent antibacterial properties, fluidity, impact resistance, and low-gloss properties.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A thermoplastic resin composition, comprising:
100 parts by weight of a base resin including (A) 50 to 70 wt % of a polycarbonate resin; and (B) 30 to 50 wt % of a butadiene-based rubber-modified aromatic vinyl-vinyl cyanide copolymer resin including a large-diameter butadiene-based rubbery polymer having an average particle diameter of 1,000 to 6,000 nm,
(C) 1 to 6 parts by weight of an ultra-high molecular weight acrylic copolymer having a weight average molecular weight of 1,000,000 to 2,000,000 g/mol; and
(D) 1 to 5 parts by weight of zinc oxide.

2. The thermoplastic resin composition of claim 1, wherein the (A) polycarbonate resin has a weight average molecular weight of 10,000 to 100,000 g/mol.

3. The thermoplastic resin composition of claim 1, wherein the (B) butadiene-based rubber-modified aromatic vinyl-vinyl cyanide copolymer resin including the large-diameter butadiene-based rubbery polymer having an average particle diameter of 1,000 to 6,000 nm comprises a continuous phase of an aromatic vinyl-vinyl cyanide copolymer and a dispersed phase of a butadiene-based rubber-modified aromatic vinyl-vinyl cyanide graft copolymer having a core-shell structure including the large-diameter butadiene-based rubbery polymer.

4. The thermoplastic resin composition of claim 3, wherein the aromatic vinyl-vinyl cyanide copolymer is a styrene-acrylonitrile copolymer.

5. The thermoplastic resin composition of claim 3, wherein the butadiene-based rubber-modified aromatic vinyl-vinyl cyanide graft copolymer having the core-shell structure including the large-diameter butadiene-based rubbery polymer having an average particle diameter of 1,000 to 6,000 nm is an acrylonitrile-butadiene-styrene graft copolymer.

6. The thermoplastic resin composition of claim 1, wherein the (C) ultra-high molecular weight acrylic copolymer having a weight average molecular weight of 1,000,000 to 2,000,000 g/mol is an ultra-high molecular weight methyl methacrylate-ethyl acrylate copolymer.

7. The thermoplastic resin composition of claim 1, wherein the (D) zinc oxide has an average particle diameter of 0.5 to 3 m.

8. The thermoplastic resin composition of claim 1, wherein the (D) zinc oxide has a BET specific surface area of 1 to 10 m²/g.

9. The thermoplastic resin composition of claim 1, wherein the (D) zinc oxide has a peak position 20 value of 35 to 370 in X-ray diffraction analysis, and a crystallite size value according to Equation 1 of 1,000 to 2,000 Å,
$$Crystallite size ( D ) = \frac{k λ}{β cos θ} \qquad [ Equation 1 ]$$
wherein, in Equation 1, k is a shape factor, λ is an X-ray wavelength, β is a FWHM value of an X-ray diffraction peak, and θ is a peak position value.

10. The thermoplastic resin composition of claim 1, wherein the (D) zinc oxide has a size ratio of a peak B in a 450 to 600 nm region to a peak A in a 370 to 390 nm region of 0.01 to 1 when measuring photoluminescence.

11. The thermoplastic resin composition of claim 1, wherein the thermoplastic resin composition further includes at least one additive selected from a flame retardant, a nucleating agent, a coupling agent, a filler, a plasticizer, an impact modifier, a lubricant, a release agent, a heat stabilizer, an antioxidant, an UV stabilizer, a pigment, and a dye.

12. An article manufactured from the thermoplastic resin composition of claim 1.

13. The article of claim 12, wherein the article has gloss of 5 to 25 GU measured at a reflection angle of 600 according to ASTM D523.

14. The article of claim 12, wherein the article has a melt flow index of 20 to 50 g/10 min measured under a condition of 250° C. and a 10 kg load according to ASTM D1238.

15. The article of claim 12, wherein the article has notched Izod impact strength of 25 to 50 kgf·cm/cm for a ⅛″-thick specimen according to ASTM D256.
